(19) United States
(12) Patent Application Publication
(10) Pub. No.: US 2006/0207144 A1
(43) Pub. Date: Sep. 21, 2006

(54) Adhesive labels and indicia for use in food rotation to enhance methods of food safety in the food industry

(75) Inventor: J. Michael Milliorn, Fort Worth, TX (US)

Correspondence Address: ECOLAB INC., MAIL STOP ESC-F7, 655 LONE OAK DRIVE, EAGAN, MN, 55121, US

(73) Assignee: DAYDOTS HOLDINGS, INC., Fort Worth, TX (US)

(21) Appl. No.: 11/200,726

(22) Filed: Aug. 10, 2005

Related U.S. Application Data
(63) Continuation-in-part of application No. 29/225,867, filed on Mar. 21, 2005, now Pat. No. D517122.

(51) Int. Cl. G09F 3/10

(52) U.S. Cl. 40/637; 40/638

(57) ABSTRACT

The present invention relates to adhesive labels and indicia for use in food rotation and methods to use such labels to enhance food safety. Specifically, the present invention relates to adhesive labels and indicia having text used in food safety labeling systems including at least two days of the week where a user does not need to calculate the last day of use once the label or indicia is applied.

### CROSS-REFERENCE TO RELATED APPLICATIONS

The present application is a continuation-in-part of and claims priority to U.S. patent application Ser. No. 29/225,867, filed Mar. 21, 2005, entitled COLOR CODED FOOD ROTATION LABELS, which is incorporated by reference herein in its entirety.

### FIELD OF THE INVENTION

The present invention relates to adhesive labels and indicia for use in food rotation. Specifically, the present invention relates to adhesive labels and indicia having text used in food safety labeling systems indicating at least two days of the week.

### BACKGROUND

Existing adhesive labels range in size and shape, and have specific adhesive and face materials for various specific purposes. For example, food safety and food rotation are major concerns for restaurants and other establishments involved in the storage and preparation of food for human consumption (the food services industry). In fact, the FDA food code states that any food removed from its original container must be labeled, and food must be properly rotated. To ensure such food safety and food rotation, the food services industry applies adhesive labels to the surfaces of containers holding food to inform the food handler as to the type of food and its date of preparation and/or date of possible spoilage or nonuse. These labels are a part of food safety labeling systems and food rotation systems and there are numerous variations of food safety labeling systems currently on the market.

There are three main types of labels used in these food safety labeling systems—day of the week FIFO (first in first out) systems, shelf-life/product identification labels, and use by/use first labeling. Food safety labeling systems also use an industry standard color code system of blue for Monday, yellow for Tuesday, red for Wednesday, brown for Thursday, green for Friday, orange for Saturday, and black for Sunday on the labels. These colors are used to quickly identify the days of the week on labels used in food safety labeling systems. However, different establishments use labels indicating the day of the week to mean different things. For example, some restaurants use the day of the week label to indicate the day of the week that the food is prepared where other restaurants use the day of the week label to indicate the day of the week that the food must be used by. This can lead to improper food rotation, confusion, and potentially the discarding of food that may still be used, or more seriously, the use of food that should be discarded.

It is against this background that the present invention has been made.

### SUMMARY

The present invention relates to adhesive labels and indicia for use in food rotation. Specifically, the present invention relates to adhesive labels and indicia having text used in food safety labeling systems indicating at least two days of the week. In some embodiments, the adhesive labels and indicia may include a number, for example, a number from 0 to 10, preferably 1 to 7, depending on the number of days that the food may be stored. In some embodiments, the adhesive labels and indicia include color, such as a color used in the industry standard color code system of blue for Monday, yellow for Tuesday, red for Wednesday, brown for Thursday, green for Friday, orange for Saturday, and black for Sunday. In some embodiments, the adhesive labels and indicia include at least two colors, such as colors used in the industry standard color code system. In some embodiments, the adhesive labels and indicia may include additional text used in food safety labeling systems such as shelf-life/product identification text. In some embodiments, the adhesive labels and indicia may include space adapted to receive text in pencil, pen, or marker. In some embodiments, the adhesive labels or indicia may be substantially shaped like a circle, square, triangle, oval, rectangle, triangle, or polygon. In some embodiments, the adhesive labels may use special adhesives or face materials that make them suitable for particular uses. In some embodiments, the adhesive labels may include a non-adhesive portion that may be used to remove the label from a surface such as a container holding food.

The present invention is advantageous over current food safety labeling systems that use the day of the week text for several reasons. First, as previously discussed, different establishments use labels indicating the day of the week to mean different things. For example, some restaurants use the day of the week label to indicate the day of the week that the food is prepared where other restaurants use the day of the week to indicate the day of the week that the food must be used by. This can lead to confusion and potentially unsafe use of food because the meaning of the day of the week is subject to interpretation. Further, current food safety labeling systems that use the day of the week labels require users to perform a calculation for when the food will expire. This calculation is done either when the label is put on, or every time a user looks at the existing label, depending on which method the establishment is using. For example, if a label is put on a container of ketchup indicating that the ketchup came in on “Monday”, then every time an employee looks at that container of ketchup, the employee has to do a calculation to determine when the ketchup must be used by. This is repeated with every employee, on every shift. This calculation is time consuming and can lead to errors and potentially unsafe use of food. Many employees in the food industry do not have a high school education or do not take the time necessary to ensure proper food rotation. An example of an employee that would benefit from the present invention would be a 16 year old working at a MCDONALDS® restaurant. The present invention removes confusion by calling out on the label or indicia the first day that the label or indicia is applied, and the day that the food in the container or storage bag must be used by.

In the ketchup example, if the ketchup came into the restaurant on “Monday” and the ketchup must be used within five days of coming into the restaurant, then a user would apply an adhesive label or indicia to the container indicating the day that it came in was Monday and that the ketchup should be used by Friday. The labels of the present invention would provide several visual indicators to the user indicating the day that the ketchup came in and the day that it must be used by, including the day of the week, a color to correspond with the day of the week, and a number indicating that the ketchup must be used within five days.

These and various other features as well as advantages, which characterize the present invention, will be apparent from a reading of the following detailed description and a review of the associated drawings. It should be understood, however, that this summary, and the detailed description illustrate only some examples of various embodiments, and are not intended to be limiting to the invention as claimed.

### BRIEF DESCRIPTION OF THE DRAWINGS

FIGS. 1A to 1G illustrate an embodiment of the present invention, where a circular adhesive label is used to indicate food that may be stored for up to three days.

FIGS. 2A to 2G illustrate an embodiment of the present invention, where a circular adhesive label is used to indicate food that may be stored for up to five days.

FIGS. 3A to 3G illustrate an embodiment of the present invention, where a circular adhesive label is used to indicate food that may be stored for up to seven days.

FIGS. 4A to 4G illustrate an embodiment of the present invention, where a square adhesive label is used to indicate food that may be stored for up to three days.

FIGS. 5A to 5G illustrate an embodiment of the present invention, where a square adhesive label is used to indicate food that may be stored for up to five days.

FIGS. 6A to 6G illustrate an embodiment of the present invention, where a square adhesive label is used to indicate food that may be stored for up to seven days.

FIGS. 7 and 8 illustrate an embodiment of the present invention, where a square adhesive label includes a non-adhesive tab portion.

FIG. 9 illustrates an embodiment of the present invention, where a rectangular adhesive label includes a non-adhesive edge portion.

### DETAILED DESCRIPTION OF SOME EMBODIMENTS

The present invention and its various embodiments are described in detail below with reference to the figures. When referring to the figures, like structures and elements shown throughout are indicated with like reference numerals. Objects depicted in the figures that are covered by another object, as well as the reference annotations thereto, are shown using dashed lines.

In the food industry, most foods coming into a facility have an expiration date. It is up to the facility to effectively manage the incoming food such that the food that comes in first is used first, and the food gets used before its expiration date. The present invention provides adhesive labels and indicia to assist facilities in effectively rotating their food and using food before its expiration date. Because different foods have different shelf-lives, the present invention allows the user to select an adhesive label or indicia depending on the shelf-life of the particular food that they are labeling. For example, if the user is labeling a container of coleslaw, it may be desirable to place a label on a container of coleslaw indicating that it should be used within three days of preparation. However, a container of marinara sauce may have a longer shelf-life than a container of coleslaw, and accordingly it may be desirable to place an adhesive label on a container of marinara sauce indicating that it should be used within five days of preparation. Finally, a container of mustard has a shelf-life that is longer than a container of coleslaw or a container of marinara sauce. Accordingly, it may be desirable to place an adhesive label on the container of mustard indicating that it should be used within seven days of preparation. Alternatively, a facility may make a determination that it wants to rotate all incoming or prepared food within three days. Therefore, a facility may apply an adhesive label with the incoming or prepared day and a day three days after the incoming or prepared day to indicate when the food should be used by.

In general, the present invention relates to adhesive labels and indicia for use in food rotation and in particular, adhesive labels and indicia having text used in food safety labeling systems indicating at least two days of the week. In some embodiments, the adhesive labels and indicia may include a number, for example, a number from 0 to 10, depending on the number of days that the food may be stored. In some embodiments, the adhesive labels and indicia include color, such as a color used in the industry standard color code system of blue for Monday, yellow for Tuesday, red for Wednesday, brown for Thursday, green for Friday, orange for Saturday, and black for Sunday. In some embodiments, the adhesive labels and indicia include at least two colors, such as colors used in the industry standard color code system. In some embodiments, the adhesive labels and indicia may include additional text used in food safety labeling systems such as shelf-life/product identification text. In some embodiments, the adhesive labels and indicia may include space adapted to be written on by a user in pencil, pen, or marker. In some embodiments, the adhesive labels or indicia may be substantially shaped like a circle, square, triangle, oval, rectangle, triangle, or polygon. In some embodiments, the adhesive labels may use special adhesives or face materials that make them suitable for particular uses. In some embodiments, the adhesive labels may include a non-adhesive portion-that may be used to remove the label from a container holding food.

As previously discussed, the present invention includes a number. It is understood that the present invention may include any combination of numbers from 0 to 10, for example from 0 to 1,000,000. However, when the adhesive labels and indicia of the present invention are used to indicate a food rotation within the days of the week, the adhesive labels and indicia preferably include a number between 1 and 7.

As used herein the term “food”, means any food or beverage item that may be consumed by a human. For example, the term “food” includes the following: meat products including ready-to-eat meat products, processed meats, cooked meats and raw meats including beef, pork and poultry products; fish products including cooked and raw fish; produce including whole or cut fruits and vegetables, and cooked or raw fruits and vegetables; condiments such as ketchup, mustard, mayonnaise and salad dressing; sauces such as marinara sauce and alfredo sauce; prepared items such as casseroles, coleslaw; salads such as fruit salad, pasta salad, and vegetable salad; prepared soups; breads such as yeast breads, buns, and other baked goods; desserts including cakes, bars, cookies, and candy; snack items including potato chips, pretzels, and tortilla chips; prepared sandwiches including submarine sandwiches and wraps; beverages including carbonated soda, alcoholic beverages, water, Gatorade™, and fruit juice beverages; breakfast items including cereal, and breakfast bars and the like. As used herein, the term “food” includes fresh, refrigerated, frozen, and shelf items. The term “food” also includes items that are pre-packaged or prepared prior to their arrival at a facility as well as items that are prepared from ingredients on-site.

The food item may be in a container, packaged, and not packaged. When an adhesive label or indicia is applied to a food item, it may be applied directly to the food item itself, to the container that the food item is in, or to the packaging of the individual food item, or the adhesive label or indicia may be applied to the packaging containing several individual food items, such as a box, or shrink wrap on a pallet.

The present invention may be used in a variety of food establishments and facilities. For example, the present invention may be used in restaurants, bars, grocery stores, school cafeterias, nursing homes, airlines, convenience stores, warehouse stores, delicatessens, coffee shops, and the like.

The present invention relates to adhesive labels and indicia. Adhesive labels are oftentimes a very convenient way to label a product, however, at times an adhesive label may not be appropriate. For example, a cookie sheet of items may be difficult to label with an adhesive label in such a way that the adhesive label is easily visible to an employee. Under these circumstances it may be desirable to use an object having indicia pre-applied on it, where the indicia indicates at least two days of the week, color, and a number as previously discussed. Examples of surfaces where the indicia may be pre-applied, directly to a surface include storage bags, for example bags such as those commercially available under the name GLAD®, or storage bags assembled from a film or foil such as that commercially available under the name GLAD® PRESS'N SEAL™, disposable containers such as those commercially available under the name GLADWARE®; clips such as chip clips, pan clips, or clothes pins; pan and bowl covers such as those commercially available under the name SARAN™ QUICKCOVERS™; films and foils such as those commercially available under the name SARAN™, GLAD®, and REYNOLDS®V; shrink wrap; freezer tape; and the like. In some instances where food is not packaged, it may be desirable to place the indicia directly on the food article itself, for example by applying an FDA approved ink or inks directly to the food article.

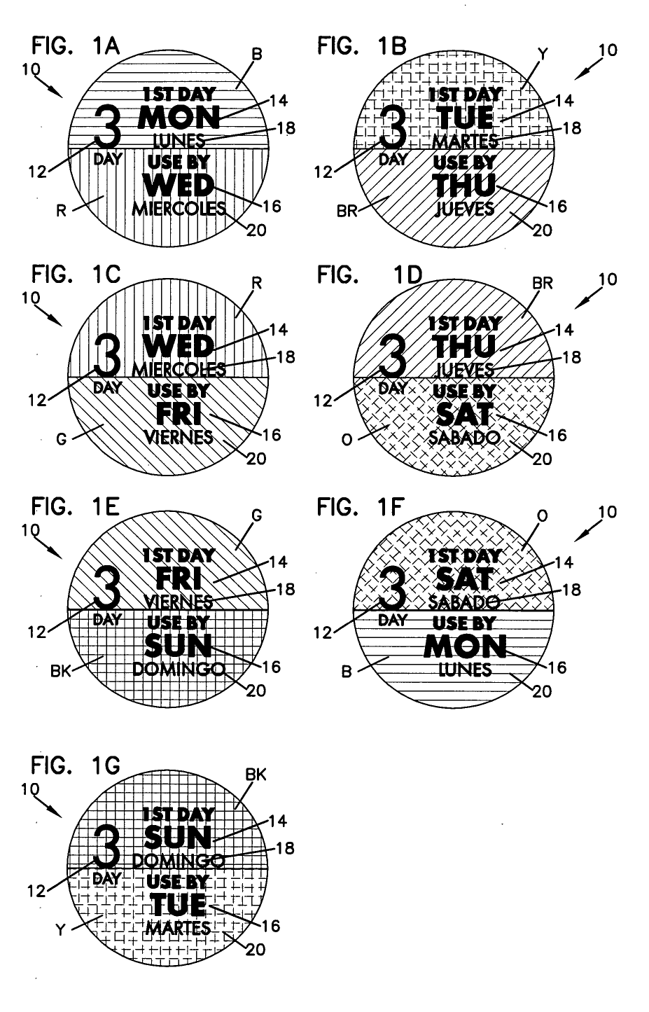

Referring now to FIGS. 1A through 6G, an adhesive label is generally shown (10). The label (10) is designed to be used as part of a food safety labeling system. The label (10) includes a number (12), for example a number from 0-10, indicating the preferred food rotation period for that particular food. For example, in FIGS. 1A through 1G, the number “3” indicates that the food may be prepared on the first day and used by the third day. The label (10) has text indicating at least two days of the week (14) and (16) where the first day (14) indicates the day the food is prepared and the second day (16) indicates the day the food must be used by. In some embodiments, the day of the week may be provided in one language. In some embodiments, the day of the week may be provided in at least two languages, as shown in FIGS. 1A through 6G where the days of the week are provided in English (14) and (16) and Spanish (18) and (20). For example, the day of the week may be provided in English, Spanish, French, Italian, German, and the like. In some embodiments, the label (10) includes color to assist in visually identifying the days of the week. In a preferred embodiment, the color used to identify the day of the week corresponds to the industry standard color code system for food safety labeling systems of blue for Monday, yellow for Tuesday, red for Wednesday, brown for Thursday, green for Friday, orange for Saturday, and black for Sunday. In FIGS. 1A through 6G, color is indicated by cross-hatching and the letters (B) for blue, (Y) for yellow, (R) for red, (BR) for brown, (G) for green, (O) for orange, and (BK) for black.

FIGS. 1A through 1G specifically show a circular shaped adhesive label (10). The label (10) is designed to be used as part of a food safety labeling system. The label (10) includes the number “3” (12) to indicate that the food should be used within three days of preparation.

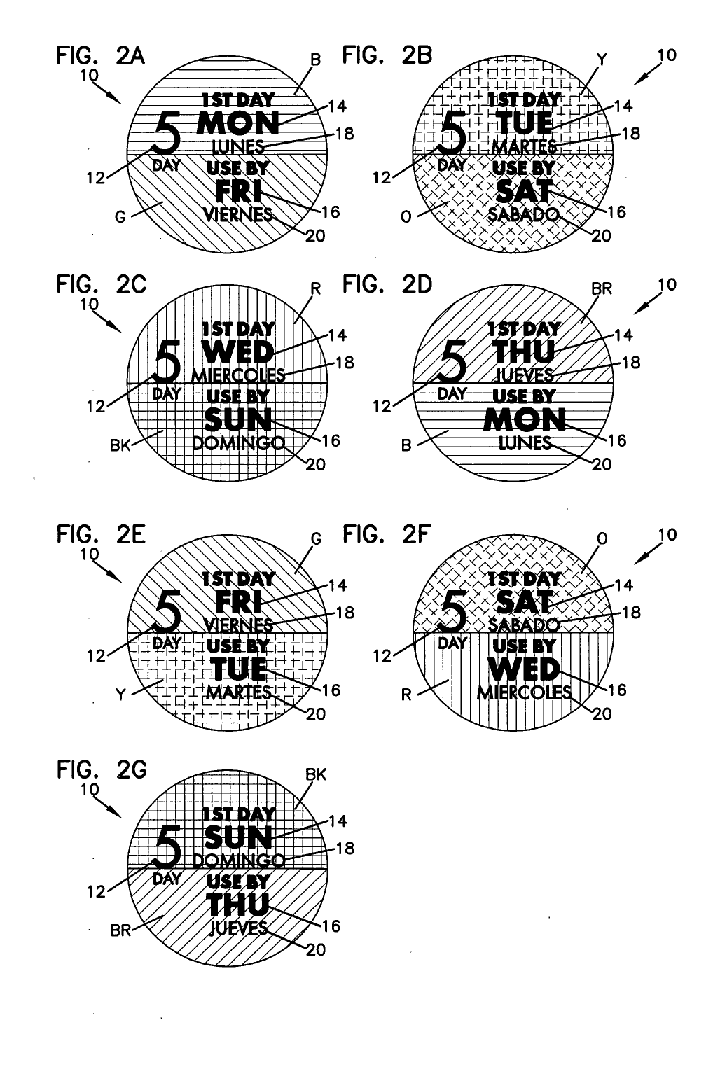

FIGS. 2A through 2G specifically show a circular shaped adhesive label (10). The label (10) is designed to be used as part of a food safety labeling system. The label (10) includes the number “5” (12) to indicate that the food should be used within five days of preparation.

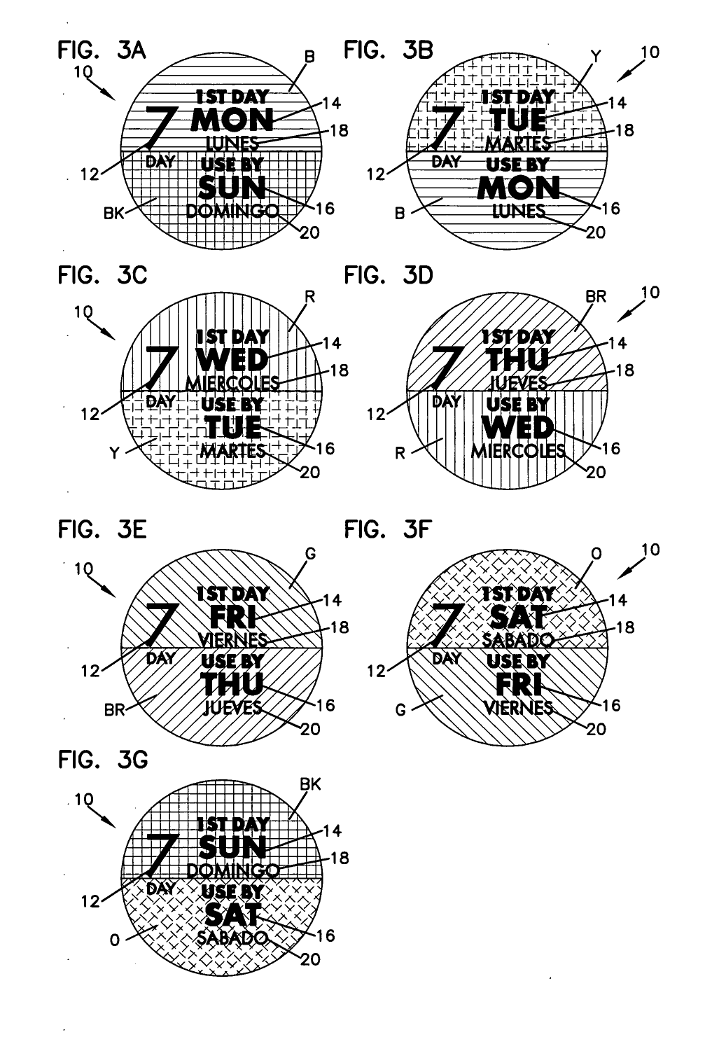

FIGS. 3A through 3G specifically show a circular shaped adhesive label (10). The label (10) is designed to be used as part of a food safety labeling system. The label (10) includes the number “7” (12) to indicate that the food should be used within seven days of preparation.

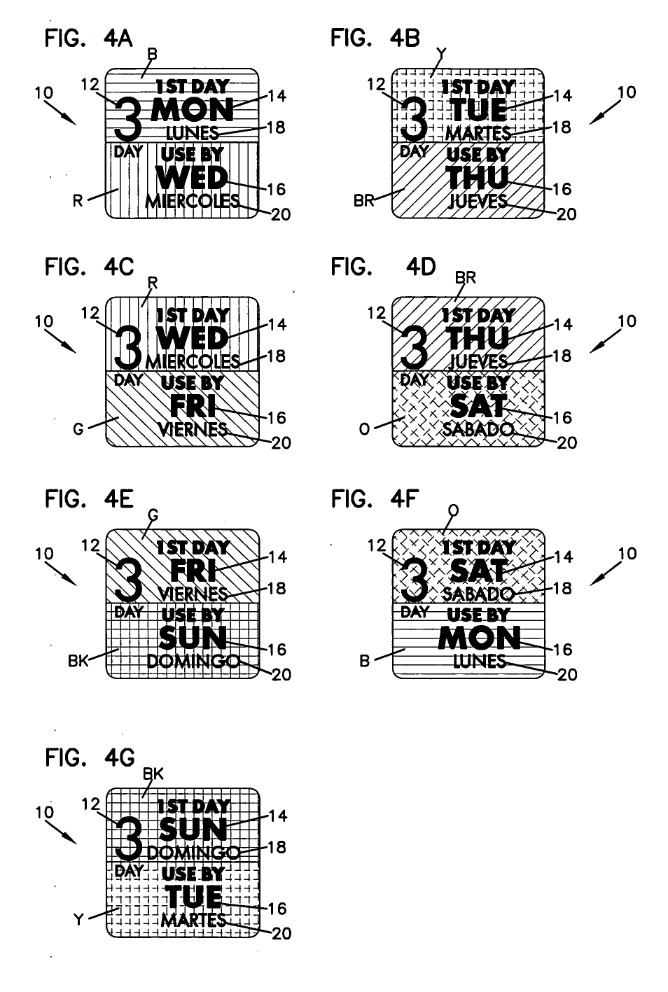

FIGS. 4A to 4G specifically show a square shaped adhesive label (10). The label (10) is designed to be used as part of a food safety labeling system. The label (10) includes the number “3” (12) to indicate that the food should be used within three days of preparation.

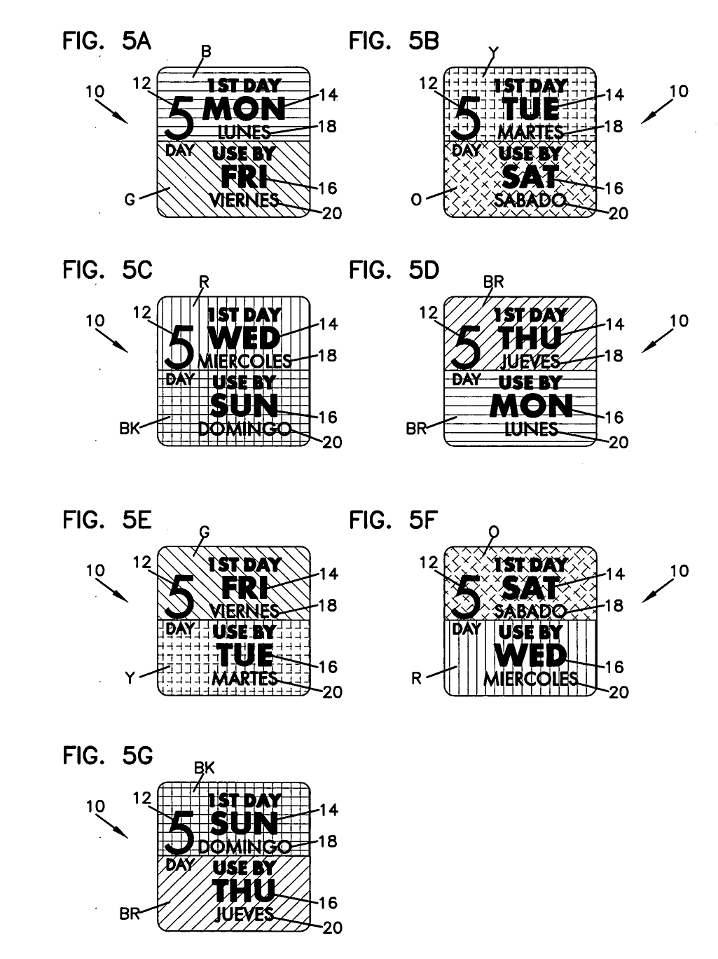

FIGS. 5A to 5G specifically show a square shaped adhesive label (10). The label (10) is designed to be used as part of a food safety labeling system. The label (10) includes the number “5” (12) to indicate that the food should be used within five days of preparation.

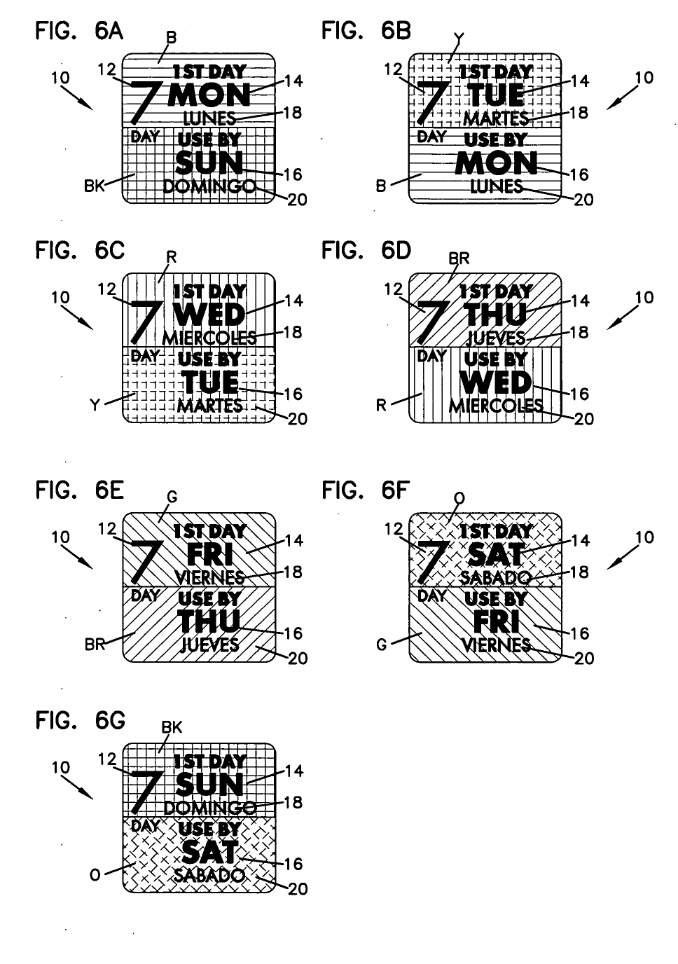

FIGS. 6A to 6G specifically show a square shaped adhesive label (10). The label (10) is designed to be used as part of a food safety labeling system. The label (10) includes the number “7” (12) to indicate that the food should be used within seven days of preparation.

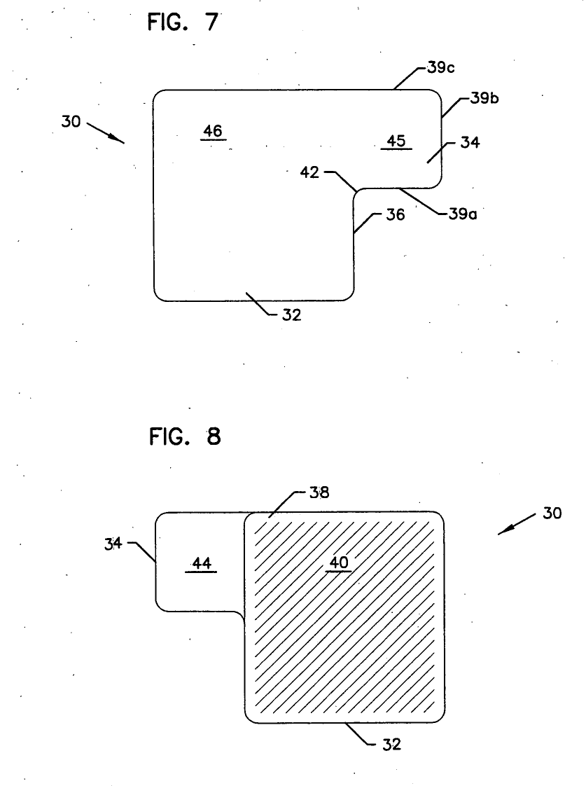

FIGS. 7 and 8 show an embodiment of the present invention, where a square adhesive label includes a non-adhesive tab portion. As shown in FIG. 7, a preferred embodiment of the present invention includes an adhesive label (30) comprising a first section (32) contiguous with the second section (34). The second section (34) forms a tab portion extending from the first section (32). The first section (32) has a first or back side (40) and a second or front side (46). The second section (34) has a first or back side (44) and a second or front side (45). Referring to FIG. 8, an adhesive layer (38) is provided on the first or back side (40) of the first section (32) for adhering the label to a receiving surface. The second or front side (46) of the first section (32) and the second or front side (45) of the second section (34) has surfaces that allow for printing or writing thereon. Referring to FIG. 8, there is shown back view of the adhesive label (30). As shown, the adhesive layer (38) is provided across the first or back side (40) of only the first section (32) of the label (30), and the first or back side (44) of the second section (34) does not include an adhesive layer (38). In this way, the user of the label (30) places the label (30), or more specifically the first section (32), in contact with the substrate surface. The tab portion (34) which does not include an adhesive layer, the first or back side (44) remains free from attachment to the substrate surface. To remove the label (30), the user simply grasps the tab portion (34) and pulls upwardly on the tab, thereby lifting the label (30) off of the substrate. Referring to FIG. 7, the tab portion (34) is shown having edges (39a to c) in which lower and upper side edges (39a) and (39c) respectively are parallel to each other and edge (39b) is the outer edge of tab (34). As illustrated, it is a preferred embodiment that the lower edge (39a) converges with the edge (36) of the first section (32) from which the tab portion (34) extends. The first section (32) can be in several different shapes.

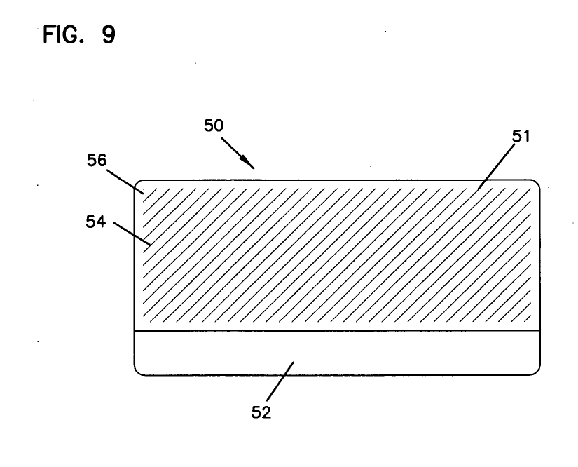

FIG. 9 illustrates an embodiment of the present invention, where a rectangular adhesive label includes a non-adhesive edge portion. FIG. 9 shows the back side (54) of a label (50) that comprises a substantially rectangular section including an edge portion (52) that is substantially free of any adhesive. The remaining portion of the back side (54) of the label (50) includes an adhesive layer (56). As described above, the purpose of the substantially adhesive-free edge portion (52) is to provide a user of the label (50) with the means for grasping the label (50) and removing it from the substrate by pulling upwardly on the edge portion (52).

FIGS. 7, 8 and 9 show square adhesive labels and rectangular adhesive labels having non-adhesive tab portions and edge portions respectively. It is understood that the present invention-includes adhesive labels that are substantially shaped like a circle, square, triangle, oval, rectangle, or polygon and include a non-adhesive portion, for example, a tab portion or an edge portion.

An adhesive label is a construction of three elements: face material, adhesive, and liner. Face material is most commonly paper, but can also be polyester, vinyl, polypropylene, foil, cellulose, such as carboxymethyl cellulose, polyvinyl alcohol, and paper, films, and foils commonly used for labels, and the like. The type of face material selected for a label is determined by the intended use of the label and the desired quality of printing. For example, paper labels are preferable because they are inexpensive. Polypropylene labels and other film labels are particularly useful for very wet environments or where the label should be removed without tearing or leaving a residue. An example of a polypropylene face material is FASSON® 3.8M Matte White Polypropylene/R-10 having Specification No. 75359, which is sold by AVERY DENNISON (250 Chester Street, Painesville, Ohio 44077). Finally, cellulose or polyvinyl alcohol labels are particularly useful for situations where it is beneficial if the label dissolves upon getting wet (i.e., when a container is placed in a warewashing machine).

The adhesive labels of the present invention may use a variety of adhesive materials. Examples of suitable adhesives include permanent adhesives, removable adhesives, water-soluble adhesives, cold temperature adhesives, and adhesives that may withstand a wide range of temperatures. Permanent adhesives are particularly useful for labeling a surface that will be discarded. Removable adhesives are particularly useful for labeling surfaces that will be reused, such as pans. Water-soluble adhesives are particularly useful for containers that will be washed, where a label may be inadvertently left on the container after the food is used or discarded. Cold temperature adhesives are particularly useful for containers that will be stored at cold temperatures.

The liner is a silicone coated sheet of paper that allows the face material and adhesive to be easily removed for application on other surfaces. An example of liner paper for constructing the roller sheet of labels is sold by AVERY DENNISON under the trade name FASSON® 320LF.

In addition to having text indicating at least two days of the week, the adhesive labels and indicia of the present invention may include additional types of text used in food safety labeling systems including shelf-life/product identification text and use by/use first text. For example, shelf-life/product identification text includes text relating to the name of the product, the time the product was created, the employee that created it, the quantity, the manager, and the like.

The adhesive labels and indicia of the present invention may includes a space that is adapted to receive text in pencil, pen, or marker.

The present invention has been described as an adhesive label or indicia having at least two days of the week. However, it is understood that additional labels and indicia are within the scope of the present invention. For example, a label having places to put individual day of the week labels, thereby allowing the user to customize the time between the first day and the last day are believed to be within the scope of the present invention. Further, a label having at least two dates other than days of the week, for example, months or years, are believed to be within the scope of the present invention. Such labels would be useful in the food service industry, institutional industry, or consumer industry, for example, for indicating the shelf-life of batteries, or when equipment should be serviced.

The foregoing summary, detailed description, and examples provide a sound basis for understanding the invention, and some specific example embodiments of the invention. Since the invention can comprise a variety of embodiments, the above information is not intended to be limiting. The invention resides in the claims.

What is claimed is:

1. A method of food rotation comprising:
a) providing at least two different adhesive labels, each adhesive label comprising;
i) a front surface having a number from 1 to 7, a first day of the week and a first color, and a second day of the week and a second color, wherein the number on the first adhesive label is different from the number on the second adhesive label;
ii) a back surface; and
iii) an adhesive layer located on the back surface;
b) determining the rotation period of a food product;
c) selecting from the at least two different adhesive labels the label that corresponds with the rotation period of the food product; and
d) applying the adhesive label to the surface of the food, or the container or packaging holding the food product.

2. The method of claim 1, wherein the adhesive label is in a shape selected from the group consisting of a square shape, a triangular shape, a rectangular shape, a circular shape, an oval shape, and a polygon shape.

3. The method of claim 1, the adhesive label further comprising a portion that is substantially free of adhesive.

4. The method of claim 3, wherein the portion that is substantially free of adhesive is a tab portion.

5. The method of claim 3, wherein the portion that is substantially free of adhesive is an edge portion.

6. The method of claim 1, wherein the label is fabricated from material selected from the group consisting of paper, polypropylene, foil, cellulose, polyvinyl alcohol, and mixtures thereof.

7. The method of claim 1, wherein the front surface is adapted to accept printing of text.

8. The method of claim 1, wherein the first and second color printed on the front surface is related to an industry standard color code system used in food safety labeling systems.

9. The method of claim 8, wherein the industry standard color code system is selected from a group of colors consisting of blue for Monday, yellow for Tuesday, red for Wednesday, brown for Thursday, green for Friday, orange for Saturday, and black for Sunday.

10. The method of claim 1, wherein the first day of the week and the second day of the week are in at least one language selected from the group consisting of English, Spanish, French, Italian, and German.

11. The method of claim 1, wherein the first day of the week and the second day of the week are in at least two languages selected from the group consisting of English, Spanish, French, Italian, and German.

12. The method of claim 1, wherein the adhesive is selected from the group consisting of permanent, removable, water-soluble, and cold temperature adhesives, and mixtures thereof.

13. The method of claim 1, wherein the selection of the adhesive label is performed by someone other than the employee applying the adhesive label.

14. The method of claim 1, wherein no additional calculation of the food rotation period is needed after the adhesive label is applied.

15. A food rotation adhesive label system comprising at least a first and second adhesive label, each adhesive label comprising:
a) a front surface having a number from 1 to 7, a first day of the week and a first color, and a second day of the week and a second color;
b) a back surface; and
c) an adhesive layer located on a back surface, wherein the adhesive label is adapted to be
i) applied to the surface of a container holding food
ii) remain on the container for a period of time; and
iii) removed from the surface of the container holding food
wherein the number on the first adhesive label is different from the number on the second adhesive label.

16. The system of claim 15, wherein the adhesive label is in a shape selected from the group consisting of a square shape, a triangular shape, a rectangular, a circular shape, an oval shape, and a polygon shape.

17. The system of claim 15, the adhesive label further comprising a portion that is substantially free of adhesive.

18. The system of claim 17, wherein the portion that is substantially free of adhesive is a tab portion.

19. The system of claim 17, wherein the portion that is substantially free of adhesive is an edge portion.

20. The system of claim 15, wherein the adhesive label is fabricated from a material selected from the group consisting of paper, polypropylene, foil, cellulose, polyvinyl alcohol, and mixtures thereof.

21. The system of claim 15, wherein the front surface is adapted to accept printing of text.

22. The system of claim 15, wherein the first and second color printed on the front surface is related to an industry standard color code system used in food safety labeling systems.

23. The system of claim 22, wherein the industry standard color code system is selected from the group of colors consisting of blue for Monday, yellow for Tuesday, red for Wednesday, brown for Thursday, green for Friday, orange for Saturday, and black for Sunday.

24. The system of claim 15, wherein the first day of the week and the second day of the week are in at least one language selected from the group consisting of English, Spanish, French, Italian, and German.

25. The system of claim 15, wherein the first day of the week and the second day of the week are in at least two languages selected from the group consisting of English, Spanish, French, Italian, and German.

26. The system of claim 15, wherein the adhesive is selected from the group consisting of permanent, removable, water-soluble, and cold temperature adhesives, and mixtures thereof.

27. The system of claim 15, further comprising a third adhesive label.

28. The system of claim 27, wherein the first adhesive label comprises the number “3”, the second adhesive label comprises the number “5”, and the third adhesive label comprises the number “7”.

29. The system of claim 27, wherein the first adhesive label comprises the number “2”, the second adhesive label comprises the number “4”, and the third adhesive label comprises the number “6”.
